(19) United States
(12) Patent Application Publication
(10) Pub. No.: US 2026/0138450 A1
(43) Pub. Date: May 21, 2026

(54) MOTOR VEHICLE HAVING MULTIPLE OPERATOR CONTROL SCREENS

(71) Applicant: Bayerische Motoren Werke Aktiengesellschaft, Muenchen (DE)

(72) Inventors: Florian Miedl, Moosburg an der Isar (DE); Lorand Lucian Nagy, Muenchen (DE); Hans-Joachim Krause, Eching (DE); Stefan Francke, Muenchen (DE); Tobias Glohr, Muenchen (DE)

(21) Appl. No.: 18/705,785

(22) PCT Filed: May 30, 2022
(86) PCT No.: PCT/EP2022/064610

§ 371 Date: Apr. 29, 2024

(30) Foreign Application Priority Data
Nov. 15, 2021 (DE) 10 2021 129 690.0

(51) Int. Cl. B60H 1/00; A63F 13/26; B60K 35/22; B60R 16/023

(52) U.S. Cl. CPC B60K 35/28; B60K 35/22; B60H 1/0065; B60K 2360/1438; B60K 2360/164; B60K 2360/182

(57) ABSTRACT

A motor vehicle with a plurality of operator control screens is disclosed herein. The motor vehicle includes a driver seat, a plurality of passenger seats, a plurality of vehicle-integrated operator control screens at the corresponding plurality of passenger seats, and a vehicle-integrated communication network configured to enable a data communication between the plurality of operator control screens. Each of the plurality of operator control screens is configured to (i) enable a passenger to control one or more vehicle components of the motor vehicle, and (ii) provide a common multiplayer video game for a plurality of passengers at the corresponding plurality of operator control screens.

### CROSS-REFERENCE TO RELATED APPLICATIONS

The present application is the U.S. national phase of PCT Application PCT/EP 2022/064610 filed on May 30, 2022, which claims priority of German patent application No. 10 2021 129 690.0 filed on Nov. 15, 2021, the disclosures of which are incorporated herein by reference in their entirety.

### FIELD

This disclosure relates to a motor vehicle which comprises multiple operator control screens, in particular at a front passenger seat and/or at one or more rear seats of the vehicle.

### BACKGROUND

A motor vehicle can have control elements at each of different passenger seats, in particular at front passenger seat and/or at one or more rear seats, which enable a passenger at the respective seat position to control one or more components of the vehicle, such as a climate control system or an infotainment system.

Accordingly, it would be advantageous to increase the level of comfort of passenger seats of a motor vehicle.

### SUMMARY

According to one embodiment, a motor vehicle (in particular a passenger vehicle) is described. The motor vehicle comprises a driver seat and a plurality of passenger seats. The passenger seats can in particular be rear seats of the vehicle. A passenger seat can optionally be a front passenger seat of the vehicle.

The motor vehicle furthermore comprises a plurality of vehicle-integrated operator control screens at the corresponding plurality of passenger seats. The individual operator control screens can each be integrated into the interior trim of the vehicle. The integration can be such that the individual operator control screens cannot be removed or at least cannot be removed without a tool from the vehicle by the individual passengers.

The motor vehicle can have a plurality of doors at the corresponding plurality of passenger seats. The plurality of operator control screens can then be arranged on the corresponding plurality of doors, in particular on door panels of the corresponding plurality of doors, and/or can be (permanently) integrated therein.

Furthermore, the motor vehicle comprises a vehicle-integrated communication network (such as an Ethernet network), which is designed to enable a data communication between the plurality of operator control screens. The communication network can be designed as at least partially or completely wired (such as Ethernet) and/or at least partially or completely wireless (such as WLAN).

The individual operator control screens of the plurality of operator control screens can each be designed to enable a passenger to control one or more vehicle components of the motor vehicle. The one or more vehicle components can comprise: a climate control system of the motor vehicle, a fan of the motor vehicle, a seat heater, and/or an infotainment system of the motor vehicle. The individual operator control screens can thus be used (in a standard manner) to perform comfort settings at the individual passenger seats.

The individual operator control screens of the plurality of operator control screens can furthermore each be designed to provide a common multiplayer video game for the plurality of passengers at the corresponding plurality of operator control screens. The motor vehicle can be designed to effectuate a data communication (such as an Ethernet communication) between the plurality of operator control screens via the communication network to provide the multiplayer video game.

It can thus be made possible for the passengers of the vehicle to additionally use the operator control screens as game consoles for mutually playing with one another. The level of comfort for the passengers can thus be increased efficiently.

The individual operator control screens of the plurality of operator control screens can each comprise a touch-sensitive screen, on which an interactive visual display having one or more control symbols operable by a passenger is displayable. The individual operator control screens of the plurality of operator control screens can be designed to display a first visual display having one or more first control symbols for controlling the one or more vehicle components. Furthermore, the individual operator control screens of the plurality of operator control screens can be designed to display a second visual display, differing therefrom, having one more second control symbols to provide the multiplayer video game.

The graphic user interface of the individual operator control screens can thus be adapted for the provision of the multiplayer video game. A common video game can thus be provided for multiple passengers of the vehicle in a particularly efficient manner.

The individual operator control screens of the plurality of operator control screens can each be designed as a game controller of the multiplayer video game for the individual passengers. Alternatively or additionally, the individual operator control screens of the plurality of operator control screens can each be designed to play back video contents of the multiplayer video game. The individual operator control screens can thus be designed as game consoles, which are connected to one another via the communication network of the vehicle. A common video game can thus be provided for multiple passengers of the vehicle in a particularly efficient and comfortable manner.

The motor vehicle can comprise one or more display screens, in particular (integrated) on the dashboard and/or on the head unit of the motor vehicle and/or on at least one headrest of a seat of the motor vehicle. The motor vehicle can be designed to use the one or more display screens to provide the multiplayer video game, in particular to play back video contents of the multiplayer video game. The quality of the provided video game can be further increased by the integration of one or more additional display screens of the vehicle.

The motor vehicle can be designed to provide multiple different multiplayer video games via the plurality of operator control screens, which can be played with one another by the corresponding plurality of passengers. Exemplary multiplayer video games are ping-pong, tic-tac-toe, battleship, etc. At least one operator control screen of the plurality of operator control screens can be designed to select one of the multiple different multiplayer video games for common playing by the plurality of passengers. The level of comfort for the passengers of the vehicle can be further increased by the provision of different, selectable video games.

It is to be noted that the devices and systems described in this document can be used both alone and in combination with other devices and systems described in this document. Furthermore, any embodiments of the devices and systems described in this document can be combined with one another in a variety of ways. In particular, the features of the claims can be combined with one another in a variety of ways. Furthermore, features set forth between parentheses are to be understood as optional features.

### BRIEF DESCRIPTION OF THE DRAWINGS

The disclosure will be described in more detail hereinafter on the basis of exemplary embodiments. In the figures:

FIG. 1a shows an exemplary motor vehicle in a side view;

FIG. 1b shows an exemplary motor vehicle in a view from above; and

FIG. 2 shows an exemplary operator control screen.

### DESCRIPTION

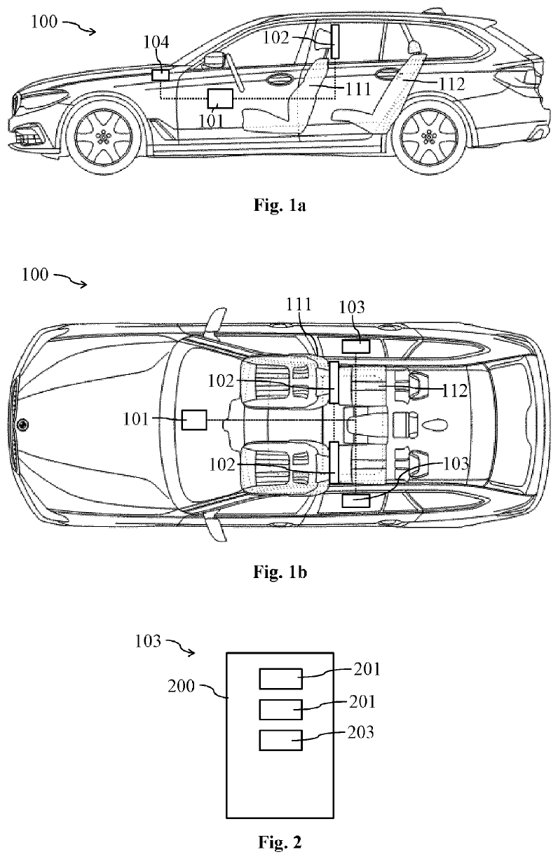

As described at the outset, the present document relates to increasing the level of comfort of passenger seats in a motor vehicle. In this context, figure la shows an exemplary motor vehicle 100 in a side view and FIG. 1b shows an exemplary motor vehicle 100 in a view from above. The vehicle 100 comprises one or more passenger seats 111 in the front area of the vehicle 100, and one or more passenger seats 112 in the rear area of the vehicle 100. Furthermore, the vehicle 100 can comprise a display screen 102 on each of the headrests of the one or more front seats 111, wherein a display screen 102 enables a passenger on a rear seat 112 to play back visual content (such as videos).

In the illustrated example, the vehicle 100 comprises an operator control screen 103 at each of the rear seats 112, wherein the operator control screen 103 of a rear seat 112 can be arranged on and/or in the door, in particular on the door panel of the door, of the rear seat 112, in particular integrated therein. The operator control screen 103 can be a touch-sensitive screen. The operator control screen 103 can enable the passenger on the respective seat 112 to control one or more components 104 of the vehicle 100, e.g., a climate control system, an infotainment system, a seat heater, etc.

FIG. 2 shows an exemplary graphic display 200 which can be displayed on an operator control screen 103. The graphic display 200 can comprise one or more control symbols 201, which can be touched by a passenger to control a vehicle component 104, for example to change the temperature of a climate control system and/or the level of a fan.

The operator control screens 103 of the vehicle 100 can be coupled with one another via a gateway 101 (for example via a central control unit) of the vehicle 100. In this case, for example, a data communication (such as a data communication via Ethernet) can be enabled between the operator control screens 103 and/or the vehicle components 104 and/or the display screens 102.

The operator control screens 103 coupled for communication can be designed to enable multiplayer video games between multiple passengers of the vehicle 100. In other words, the operator control screens 103 can be designed as coupled game consoles, which enable multiple passengers at multiple passenger seats 111, 112 to play a common video game via the respective operator control screen 103. For this purpose, the visual display 200 of the individual operator control screens 103 can have, for example, a control symbol 203, which can be actuated by the respective passenger to convert the respective operator control screen 103 into a video game controller. A visual display 200 having control symbols for a video game controller can then be represented on the operator control screen 103.

Multiple existing screen control units in a vehicle 100 can therefore be used to enable multiplayer gaming for multiple passengers with one another. The different screen control units, in particular the different operator control screens 103, can be connected to one another via Ethernet for this purpose. Multiple screen control units of the vehicle 100 can thus participate simultaneously in a video game. The level of comfort for passengers of a vehicle 100 can thus be increased efficiently.

The present disclosure is not restricted to the exemplary embodiments shown. In particular, it is to be noted that the description and the figures are only to illustrate the principle of the proposed devices and systems by way of example.

1-10. (canceled)

11. A motor vehicle comprising:
a driver seat and a plurality of passenger seats;
a plurality of vehicle-integrated operator control screens at the corresponding plurality of passenger seats; and
a vehicle-integrated communication network configured to enable a data communication between the plurality of operator control screens;
wherein each of the plurality of operator control screens is configured to:
(i) enable a passenger to control one or more vehicle components of the motor vehicle; and
(ii) provide a common multiplayer video game for a plurality of passengers at the corresponding plurality of operator control screens.

12. The motor vehicle as claimed in claim 11, wherein:
the motor vehicle has a plurality of doors at the corresponding plurality of passenger seats; and
the plurality of operator control screens are arranged on the corresponding plurality of doors, in particular on door panels of the corresponding plurality of doors.

13. The motor vehicle as claimed in claim 11, wherein the one or more vehicle components comprise one or more of the following:
a climate control system of the motor vehicle;
a fan of the motor vehicle; and
an infotainment system of the motor vehicle.

14. The motor vehicle as claimed in claim 11, wherein:
each of the plurality of operator control screens comprise a touch-sensitive screen on which an interactive visual display having one or more control symbols operable by the passenger is displayable; and
each of the plurality of operator control screens are configured to:
display a first visual display having one or more first control symbols for controlling the one or more vehicle components ; and
display a second visual display differing from the first visual display and having one or more second control symbols to provide the multiplayer video game.

15. The motor vehicle as claimed in claim 11, wherein:
the motor vehicle comprises one or more display screens arranged on one or more of (i) a dashboard, (ii) a head unit of the motor vehicle, and (iii) on a headrest of a seat of the motor vehicle; and
the motor vehicle is configured to use the one or more display screens to provide the multiplayer video game in order to play back video contents of the multiplayer video game.

16. The motor vehicle as claimed in claim 11, wherein each of the operator control screens of the plurality of operator control screens are each configured as a game controller of the multiplayer video game for the plurality of passengers.

17. The motor vehicle of claim 11, wherein each of the plurality of operator control screens are configured to play back video contents of the multiplayer video game.

18. The motor vehicle of claim 11, wherein:
the motor vehicle is configured to provide multiple different multiplayer video games via the plurality of operator control screens, which can be played with one another by the corresponding plurality of passengers; and
at least one operator control screen of the plurality of operator control screens is configured to select one of the multiple different multiplayer video games for common playing by the plurality of passengers.

19. The motor vehicle of claim 11, wherein the motor vehicle (is configured to effectuate data communication between the plurality of operator control screens via the communication network in order to provide the multiplayer video game.

20. The motor vehicle of claim 11, wherein the communication network is at least partially wired.

21. A motor vehicle comprising:
a driver seat and a plurality of passenger seats;
a plurality of doors at the corresponding plurality of passenger seats;
a plurality of vehicle-integrated operator control screens arranged on the corresponding plurality of doors at the corresponding plurality of passenger seats; and
a vehicle-integrated communication network configured to enable a data communication between the plurality of operator control screens, wherein each of the plurality of operator control screens is configured to:
(i) enable a passenger to control one or more vehicle components of the motor vehicle, said vehicle components including a climate control system, a fan, and an infotainment system; and
(ii) provide a common multiplayer video game for a plurality of passengers at the corresponding plurality of operator control screens.

22. The motor vehicle as claimed in claim 21, wherein:
the motor vehicle comprises one or more display screens arranged on one or more of (i) a dashboard, (ii) a head unit of the motor vehicle, and (iii) on a headrest of a seat of the motor vehicle; and
the motor vehicle is configured to use the one or more display screens to provide the multiplayer video game in order to play back video contents of the multiplayer video game.

23. The motor vehicle as claimed in claim 22, wherein each of the operator control screens of the plurality of operator control screens are each configured as a game controller of the multiplayer video game for the plurality of passengers.

24. The motor vehicle of claim 23, wherein each of the plurality of operator control screens are configured to play back video contents of the multiplayer video game.

25. The motor vehicle of claim 24, wherein:
the motor vehicle is configured to provide multiple different multiplayer video games via the plurality of operator control screens, which can be played with one another by the corresponding plurality of passengers; and
at least one operator control screen of the plurality of operator control screens is configured to select one of the multiple different multiplayer video games for common playing by the plurality of passengers.

26. The motor vehicle of claim 25, wherein the motor vehicle (is configured to effectuate data communication between the plurality of operator control screens via the communication network in order to provide the multiplayer video game.

27. The motor vehicle of claim 26, wherein the communication network is at least partially wired.

28. A motor vehicle comprising:
a driver seat and a plurality of passenger seats;
a plurality of vehicle-integrated operator control screens arranged at the corresponding plurality of passenger seats; and
a vehicle-integrated communication network configured to enable a data communication between the plurality of operator control screens, wherein each of the plurality of operator control screens is configured to:
(i) enable a passenger to control one or more vehicle components of the motor vehicle; and
(ii) provide a common multiplayer video game for a plurality of passengers at the corresponding plurality of operator control screens;
wherein:
each of the plurality of operator control screens comprise a touch-sensitive screen on which an interactive visual display having one or more control symbols operable by the passenger is displayable; and
each of the plurality of operator control screens are configured to:
display a first visual display having one or more first control symbols for controlling the one or more vehicle components; and
display a second visual display differing from the first visual display and having one or more second control symbols to provide the multiplayer video game.

29. The motor vehicle as claimed in claim 28, wherein:
the motor vehicle has a plurality of doors at the corresponding plurality of passenger seats; and
the plurality of operator control screens are arranged on the corresponding plurality of doors, in particular on door panels of the corresponding plurality of doors.

30. The motor vehicle as claimed in claim 29, wherein the one or more vehicle components comprise one or more of the following:
a climate control system of the motor vehicle;
a fan of the motor vehicle; and
an infotainment system of the motor vehicle.
